(19) United States
(12) Patent Application Publication
(10) Pub. No.: US 2008/0201502 A1
(43) Pub. Date: Aug. 21, 2008

(54) SYNC CIRCUIT OF DATA TRANSMISSION INTERFACE

(75) Inventor: Chun-Liang Lee, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/675,479

(22) Filed: Feb. 15, 2007

(51) Int. Cl. G06F 3/00

(52) U.S. Cl. 710/61

(57) ABSTRACT

A sync circuit of a data transmission interface connected between a first data port and a second data port is provided. The sync circuit includes a first resistor element, a capacitor element, a second resistor element, and an active element. When the signal generated by the first data port is logic 1, the active element is turned off, such that the power source end charges the capacitor element through the first resistor element. Otherwise, when the signal generated by the first data port is logic 0, the active element is turned on, such that the capacitor discharge through the second resistor element, for delaying the data of the first data port for a predetermined time and making the data of the second data port synchronously transmitted on the first data port.

### BACKGROUND OF THE INVENTION

1. Field of the Invention

The present invention relates to a sync circuit. More particularly, the present invention relates to a sync circuit applied between two different data transmission interfaces, so as to make the two different data transmission interfaces to transmit synchronously.

2. Description of Related Art

Servers have relatively high computing capability and storage capacity, and can be used by different users. In the highly developed network today, the servers play a quite important role and occupy a high ratio in the network architecture. Further, in order to accord with the high performance processing of the network, it is necessary to use a plurality of different data transmission interface peripherals, so as to assist the servers to detect or operate several special functions, thus greatly improving the performance of the servers.

The servers use a system management bus (SMBus) data transmission interface through the CPU, and transmits the data generated by the peripheral through the SMBus (for example, system temperature detection). In addition, a chassis management controller (CMC) is used to transmit the data of the peripheral. However, the CMC uses an inter-integrated circuit (I2C) Bus data transmission interface, so the CPU and the CMC use different data transmission interfaces. When the CPU is in a sleep state or is shut down, it is necessary to make the CMS to take over the control system, but the two use different data transmission interfaces, the CMC cannot access the system data such as the system temperature detection through the SMBus data transmission interface. Therefore, it is impossible to monitor the system temperature, and the server may breakdown at any moment, such that the stability of the system is greatly reduced.

As shown in FIG. 1, it is a schematic view of the architecture of a conventional server being electrically connected to peripherals. As shown in FIG. 1, the computer equipment 1 is a server having a CPU 11, a CMC 12, three first data transmission interface dace peripherals 2, and one second data transmission interface peripheral 3. Here, in order to simplify the illustration and the drawing, only one second data transmission interface peripheral 3 and three first data transmission interface peripherals 2 are taken as an example for illustration. Because the server is a commonly known server system, the functions and the internal architecture of the server will not be further illustrated in detail below.

As shown in the drawing, the CPU 11 is electrically connected to the second data transmission interface peripheral 3 through a second data transmission line 32 at a second data transmission synchronous frequency 31, and the CMC 12 is electrically connected to the first data transmission interface peripheral 2 through a first data transmission line 22 at a first data transmission synchronous frequency 21. In other words, if the CMC 12 intends to access the data of the second data transmission interface peripheral 3, it is necessary to inform the CPU 11. After the data is accessed by the CPU 11, and the data is then transmitted to the CMC 12. The CMC 12 cannot directly access the data of the second data transmission interface peripheral 3. Therefore, when the CPU 11 is in sleep state or shut down, the CMC 12 cannot acquire the status of the second data transmission interface peripheral 3. In specific, assuming that the second data transmission interface peripheral 3 is a system temperature detection apparatus, when the CPU 11 is in sleep state or shut down, the CMC 12 cannot acquire the status of the system temperature detection apparatus, such that the temperature of the server is likely to be overhigh, leading to the breakdown and instability of the server.

As shown in FIG. 2, it is a timing chart of the conventional SMBus and I2C Bus data transmission interfaces. FIG. 2 shows timing signals of the first data transmission synchronous frequency, the first data transmission line, and the second data transmission line. The first data transmission synchronous frequency is an I2C data transmission synchronous frequency (SCLK), the timing signal of the first data transmission line is an I2C data timing signal, and the timing signal of the second data transmission line is an SMBus data timing signal. However, a positive edge of the data transmission synchronous frequency is used to read the data of the I2C. Therefore, it intends to use the positive edge of the I2C Bus data transmission synchronous frequency to read the data of the SMBus. The data transmission synchronous frequency is 300 ns later than the hold time of reading the data of the SMBus, so the CMC 12 cannot access the data of the SMBus.

The data hold time of the data transmission interfaces is not synchronous, so the CMC cannot directly access the data of the peripherals through the SMBus data transmission interface. Therefore, it is a problem to be solved urgently.

### SUMMARY OF THE INVENTION

Accordingly, the present invention is directed to a sync circuit of a data transmission interface, applied to the computer equipment with two different data transmission interface peripherals and capable of effectively solving the problem that the CMC cannot access the data of the peripherals because the data timings between the two different data transmission interfaces are not synchronous.

In order to solve the above problem, the present invention provides a sync circuit of a data transmission interface connected between the first data port and the second data port. The sync circuit includes a first resistor element, a capacitor element, a second resistor element, and an active element. The capacitor element and the first resistor element are serially connected between the first voltage and the second voltage, and a common contact of the capacitor element and the first resistor element is coupled to the second data port. A first end of the second resistor is coupled to the common contact. The active element has a first end coupled to a second end of the second resistor element, a second end coupled to the first data port, and a control end coupled to a third voltage.

The present invention provides a sync circuit of a data transmission interface, applied to the computer equipment with two different data transmission interfaces. The computer equipment has a first data transmission interface peripheral and at least more than one second data transmission interface peripheral. The sync circuit of the data transmission interface is disposed between the first data port of the first data transmission interface peripheral and the second data port of the second data transmission interface peripheral, for synchronously transmitting the data therebetween. The sync circuit includes a first resistor element and a capacitor element. A first end of first resistor element is electrically connected to the power source end. A first end of the capacitor element is electrically connected to the ground end, and a second end is serially electrically connected to the first resistor element, and then electrically connected to the second data port and the first data port. When the signal generated by the first data port is logic 1, the power source end charges the capacitor element through the first resistor element. Otherwise, when the signal generated by the first data port is logic 0, the capacitor element discharges through the ground end, for delaying the data of the first data transmission interface for a predetermined time, and making the data of the second data transmission interface synchronously transmitted on the first data transmission interface.

Therefore, in the present invention, the sync circuit is mainly used to make the data lines of the two different data transmission interface accomplish the synchronous transmission, so as to solve the problem that it is impossible to directly access the data of the different data transmission interfaces because the data transmission time of the two different data transmission interfaces are not synchronous, and to guarantee the stability of the computer equipment because the data of all the peripherals can be received.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of the architecture of a conventional server being electrically connected to peripherals.

FIG. 2 is a timing chart of conventional SMBus and I2C data transmission interfaces.

FIG. 3 is a block diagram of a sync circuit of a data transmission interface according to an embodiment of the present invention.

FIG. 4 shows the sync circuit of the data transmission interface according to a first embodiment of the present invention.

FIG. 5 shows the sync circuit of the data transmission interface according to a second embodiment of the present invention.

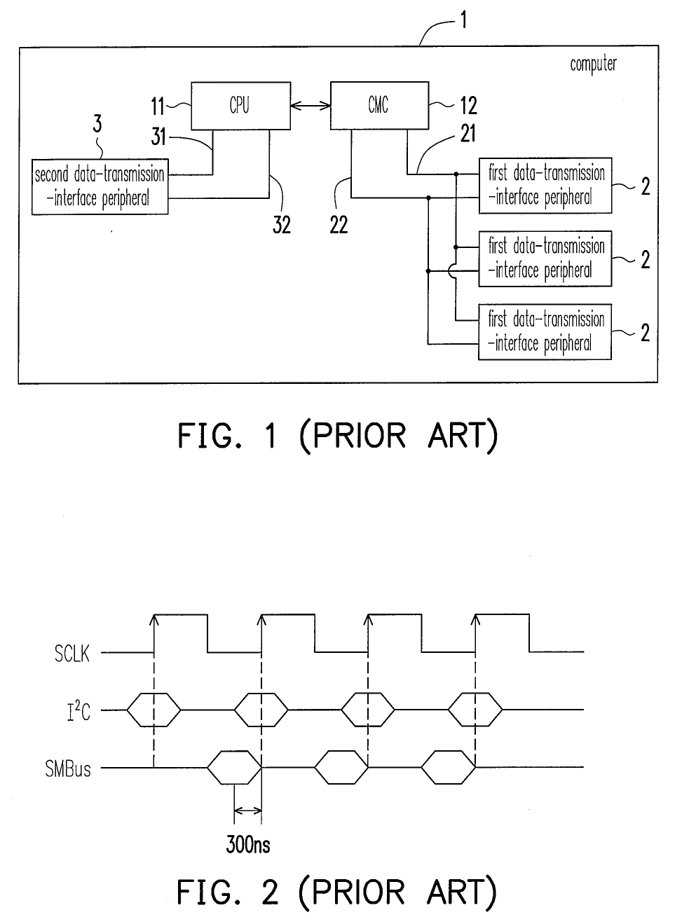

### DESCRIPTION OF EMBODIMENTS

The sync circuit of the data transmission interface of the following embodiments can be applied to the computer equipment with two different data transmission interfaces. The computer equipment at least has more than one first data transmission interface peripheral and at least more than one second data transmission interface peripheral. The sync circuit can be disposed between the first data port of the first data transmission interface peripheral and the second data port of the second data transmission interface peripheral, for synchronously transmitting the data therebetween.

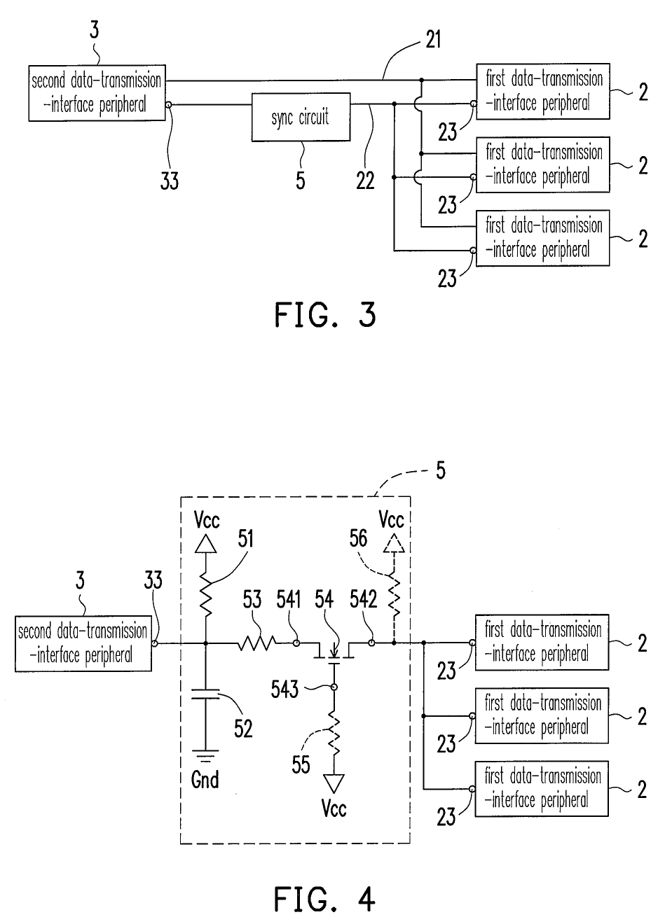

Referring to FIG. 3, it is a block diagram of the sync circuit of the data transmission interface according to an embodiment of the present invention. In order to simplify the illustration and the drawing, only three corresponding first data transmission interface peripherals 2, one second data transmission interface peripheral 3, and a sync circuit 5 are taken as an example for illustration. The numbers of the first data transmission interface peripheral 2 and the second data transmission interface peripheral 3 are not limited to this. Each of the data transmission interface peripherals 2 and 3 receives a data transmission synchronous frequency SCLK through a lead 21. The first data transmission interface peripheral 2 has the first data port 23, and the lo second data transmission interface peripheral 3 has the second data port 33. Each first data port 23 is connected in parallel to the lead 22. The sync circuit 5 is serially connected between the first data port 23 and the second data port 33, so as to regulate the data hold time of the two to be the same. The data transmission interface adopted by the first data transmission interface peripheral 2 is, for example, an I2C Bus, and the data transmission interface adopted by the second data transmission interface peripheral 3 may be an SMBus.

Here, it should be noted that the first data transmission interface peripherals 2 with the I2C Bus as the transmission interface are electrically connected to an I2C controller (not shown here), such that the first data transmission interface peripherals 2 establishes a communication passage with a south bridge chip (not shown) in the computer equipment through the I2C controller. Because the connecting relation of the I2C controller, the south bridge chip, and the peripheral are the basic architecture of the conventional computer system, the functions and the architecture will not be further described.

As shown in FIG. 4, the sync circuit of the data transmission interface according to a first embodiment of the present invention is shown. The sync circuit 5 is composed of a first resistor element 51, a capacitor element 52, a second resistor element 53, and an active element 54. The active element 54 may be a field-effect transistor (FET), a bipolar junction transistor (BJT), or a metal-oxide-semiconductor field-effect transistor (MOSFET).

The capacitor element 52 and the first resistor element 51 are serially connected between the first voltage and the second voltage, and a common contact of the capacitor element 52 and the first resistor element 51 is coupled to the second data port 33 of the second data transmission interface peripheral 3. Here, the first voltage and the second voltage may be a power source voltage Vcc and a ground voltage Gnd. The first end of the second resistor element 53 is coupled to the common contact, and the second end of the second resistor element 53 is coupled to the first end 541 of the active element 54.

The first end 541 of the active element 54 is electrically connected to the second data port 33 through the second resistor element 53, and the second end 542 is electrically connected to the first data port 23. The control end 543 of the active element 54 can be electrically connected to a third voltage (the power source voltage Vcc here) directly, and can also be electrically connected to the third voltage through the third resistor element 55. The user applying the present invention may dispose a fourth resistor element 56 in the sync circuit 5 according to the requirement. The first end of the fourth resistor element 56 is coupled to the fourth voltage (the power source voltage Vcc here), and the second end is coupled to the second end 542 of the active element 54.

When the signal generated by the first data port 23 is logic 1, the active element 54 is turned off, such that the power source voltage Vcc charges the capacitor element 52 through the first resistor element 51. Otherwise, when the signal generated by the first data port 23 is logic 0, the active element 54 is turned on, such that the capacitor element 52 discharges through the second resistor element 53. The resistor element and the capacitor element delay the data hold time of the data signal of the I2C Bus for a suitable time (for example 300 ns), such that the data of the SMBus can be transmitted on the I2C Bus. In addition, the function of the active element 54 further includes isolating the SMBus and the I2C Bus, so as to prevent the load of the SMBus from affecting the operation of the I2C Bus.

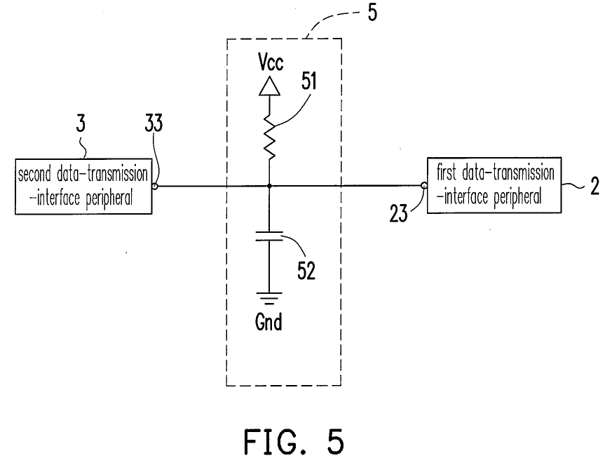

FIG. 5 is the sync circuit of the data transmission interface according to a second embodiment of the present invention. As shown in FIG. 5, the sync circuit of the data transmission interface in this embodiment is approximately the same as that of the above embodiment, except that in this embodiment, the active element 54 is not used as the control element for the charging and discharging of the first resistor element 51 and the capacitor element 52, and the logic 1 or 0 of the data signal sent by the data port 33 of the I2C data transmission interface peripheral 3 is directly used as the charging and discharging control of the first resistor element 51 and the capacitor element 52. In addition, the second resistor element 53 is omitted. It should be noted that this embodiment is applied to the computer equipment 1 in the condition of only having one I2Cbus peripheral and one SMBus peripheral, so as to prevent the load effect from affecting the data transmission function.

When the logic signal generated by the first data port 23 is 1, the power source voltage Vcc charges the capacitor element 52 through the first resistor element 51. Otherwise, when the logic signal generated by the first data port 23 is logic 0, the capacitor element 52 discharges through the ground voltage Gnd. The resistor element and the capacitor element are used to delay the data hold time of the data signal of the I2C for 300 ns, such that the data of the SMBus can be transmitted on the I2C Bus.

To sum up, in the sync circuit of the data transmission interface of the present invention, the RC delay circuit composed of the resistor element and the capacitor element is mainly used to solve the problem that it is impossible to achieve the synchronous data transmission of the different data transmission interfaces because the data hold times of the data lines of the two different data transmission interfaces are different, and to access the date operated by all the peripherals and guarantee the stability of the computer equipment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sync circuit of a data transmission interface connected between a first data port and a second data port, comprising:
a first resistor element;
a capacitor element, serially connected between a first voltage and a second voltage with the first resistor element, wherein a common contact of the capacitor element and the first resistor element is coupled to the second data port;
a second resistor element, with a first end coupled to the common contact; and
an active element, having a first end coupled to the second end of the second resistor element, a second end coupled to the first data port, and a control end coupled to a third voltage.

2. The sync circuit of the data transmission interface as claimed in claim 1, wherein the transmission interface adopted by the first data port is an inter-integrated circuit (I2C) bus.

3. The sync circuit of the data transmission interface as claimed in claim 1, wherein the transmission interface adopted by the second data port is a system management bus (SMBus).

4. The sync circuit of the data transmission interface as claimed in claim 1, wherein the active element is one of a field-effect transistor (FET), a bipolar junction transistor (BJT), and a metal-oxide-semiconductor field-effect transistor (MOSFET).

5. The sync circuit of the data transmission interface as claimed in claim 1, wherein the first voltage is a power source voltage, and the second voltage is a ground voltage.

6. The sync circuit of the data transmission interface as claimed in claim 1, wherein the third voltage is a power source voltage.

7. The sync circuit of the data transmission interface as claimed in claim 1, further comprising a third resistor element, wherein the control end of the active element is coupled to the third voltage through the third resistor element.

8. The sync circuit of the data transmission interface as claimed in claim 1, further comprising a fourth resistor element with a first end coupled to a fourth voltage and a second end coupled to the second end of the active element.

9. The sync circuit of the data transmission interface as claimed in claim 8, wherein the fourth voltage is a power source voltage.

10. The sync circuit of the data transmission interface as claimed in claim 1, wherein when a signal generated by the first data port is logic 1, the active element is turned off, such that the capacitor element charges; and
when the signal generated by the first data port is logic 0, the active element is turned on, such that the capacitor element perform discharges.

11. A sync circuit of the data transmission interface, applied to a computer equipment with two different data transmission interfaces, wherein the computer equipment has a first data transmission interface peripheral and at least more than one second data transmission interface peripheral, the sync circuit is disposed between the first data port of the first data transmission interface peripheral and the second data port of the second data transmission interface peripheral, for synchronously transmitting the data between therebetween, the sync circuit comprising:
a first resistor element, with the first end electrically connected to the power source end; and
a capacitor element, with a first end electrically connected to the ground end, and a second end serially and electrically connected to the first resistor element, electrically connected to the second data port and the first data port; wherein when the signal generated by the first data port is logic 1, the power source end charges the capacitor element through the first resistor element, otherwise, when the signal generated by the first data port is logic 0, the capacitor element discharges through the ground end, for delaying the data of the first data transmission interface for a predetermined time, and making the data of the second data transmission interface synchronously transmitted on the first data transmission interface.

12. The sync circuit of the data transmission interface as claimed in claim 11, wherein the transmission interface adopted by the first data transmission interface peripheral is an I2C (inter-integrated circuit) bus.

13. The sync circuit of the data transmission interface as claimed in claim 11, wherein the transmission interface adopted by the second data transmission interface peripheral is a SMBus (system management bus).
